(19) United States
(12) Patent Application Publication
(10) Pub. No.: US 2019/0034896 A1
(43) Pub. Date: Jan. 31, 2019

(54) SYSTEM AND METHOD FOR DYNAMICALLY CONTROLLING THE PRICING INFORMATION OF THE SELF-SERVICE TERMINAL

(71) Applicant: Convipay Inc., Dover, DE (US)

(72) Inventors: Anshoo Gaur, Naperville, IL (US); Aroon Ashish Khatter, Dover, DE (US)

(21) Appl. No.: 15/662,346

(22) Filed: Jul. 28, 2017

(51) Int. Cl. G06Q 20/18; G06F 17/30; G06Q 10/08; G06Q 20/20; G06Q 30/02

(52) U.S. Cl. CPC G06Q 20/18; G06F 17/30339; G06Q 30/0206; G06Q 20/201; G06Q 10/087

(57) ABSTRACT

The present invention discloses a system and method for dynamically controlling the pricing information of the self-service terminal. The system may comprise one or more processors and a memory coupled with the one or more processors. The system and method may comprise displaying, a planogram on the operator device. The planogram may be depicting a matrix of rows and columns accommodating a plurality of products associated with the self-service terminal, wherein an intersection of a row and a column indicates a cell. The system and method may comprise enabling, via the operator device or the remote server, an operator to dynamically set a price associated with an individual product within an individual cell of the matrix. The price set for the individual product is either same or different from one or more products within a same row or a same column, corresponding to said individual product, in the matrix.

### CROSS-REFERENCE TO RELATED APPLICATIONS AND PRIORITY

The present application does not claim priority from any other patent application(s).

### TECHNICAL FIELD

The present invention in general relates to a system and method for dynamically controlling the pricing information of the self-service terminal.

### BACKGROUND

Vending device enables dispensing products or items such as snacks, beverages, tickets or any other products or services to the customers automatically once the customer inserts currency coins or notes into the said vending device. Such devices typically contain a number of different products/services from which the consumer may choose a desired product/service to be vend by the vending device. After inserting the appropriate amount of money into the vending device and entering a product selection, the selected goods are dispensed to the consumer. Some vending devices accepts cashless payments for vending products from the vending devices. Such devices are usually installed in airports, railway stations, pubs, café s, shopping malls, other publicly accessible buildings and streets to provide easy access to the users.

The vending devices available in market allows only row and column wise product arrangement in storage compartment. The row comprises plurality of columns with same or different type of products of same price. The column comprises the entire line of product of same type with same price. The operator of the vending device manually sets the same price of the one or more products stored in the plurality of columns of the same row of the vending device. Sometimes vending device runs out of stock for a particular product and the operator wants to use that available space for other type of product with different price. Above mentioned arrangement of the products in the vending device may limit the utilization of the space of the vending device for different type of products with different price in the same row.

Therefore, there is long standing need of system and method for dynamically controlling of the pricing information of the self-service terminal which can accommodate same or different type of products in the same row with different price.

### SUMMARY

Before the present system and its method of use is described, it is to be understood that this disclosure is not limited to the particular apparatus and its arrangement as described, as there can be multiple possible embodiments which are not expressly illustrated in the present disclosure. It is also to be understood that the terminology used in the description is for the purpose of describing the particular versions or embodiments only, and is not intended to limit the scope of the present application. This summary is not intended to identify essential features of the subject matter nor it is intended for use in detecting or limiting the scope of the proposed subject matter.

In one embodiment, a system for dynamically controlling pricing information associated with one or more products of a self-service terminal is described. The system may comprise one or more processors and a memory coupled with the one or more processors. The one or more processors may be configured to execute instructions stored in the memory. In one aspect, the one or more processors may execute instruction for displaying a planogram on the operator device. The planogram may be depicting a matrix of rows and columns accommodating a plurality of products associated with the self-service terminal, wherein an intersection of a row and a column indicates a cell accommodating a product of the plurality of products. Further, the one or more processors may execute instructions for enabling, via the operator device or the remote server, an operator to dynamically set a price associated with an individual product within an individual cell of the matrix. In one aspect, the price set for the said individual product is either same or different from one or more products within a same row or a same column, corresponding to said individual product, in the matrix.

In another embodiment, a method for dynamically controlling pricing information associated with one or more products of a self-service terminal is disclosed. The method may comprise displaying, via one or more processors, a planogram on an operator device, depicting a matrix of rows and columns accommodating a plurality of products associated with the self-service terminal. In one aspect, the intersection of a row and a column indicates a cell accommodating a product of the plurality of products. The method may further comprise enabling, via the one or more processors, an operator to dynamically set a price associated with an individual product within an individual cell of the matrix using the operator device or remote server. In one aspect, the price set for the said individual product is either same or different from one or more products within a same row or a same column, corresponding to said individual product, in the matrix.

In yet another embodiment, a non-transitory computer readable medium storing a program for dynamically controlling pricing information associated with one or more products of a self-service terminal is disclosed. The program may comprise programmed instructions. The programmed instructions may comprise instructions for displaying, via one or more processors, a planogram on an operator device, depicting a matrix of rows and columns accommodating a plurality of products associated with the self-service terminal. In one aspect, the intersection of a row and a column indicates a cell accommodating a product of the plurality of products. The programmed instructions may further comprise instructions for enabling, via the one or more processors, an operator to dynamically set a price associated with an individual product within an individual cell of the matrix using the operator device or remote server. In one aspect, the price set for the said individual product is either same or different from one or more products within a same row or a same column, corresponding to said individual product, in the matrix.

### BRIEF DESCRIPTION OF DRAWINGS

The detailed description is described with reference to the accompanying Figures. In the Figures, the left-most digit(s) of a reference number identifies the Figure in which the reference number first appears. The same numbers are used throughout the drawings to refer like features and components.

FIG. 1 illustrates an implementation 100 of a system 101 for dynamically controlling pricing information associated with one or more products of a self-service terminal, in accordance with an embodiment of the present subject matter.

FIG. 2 illustrates the system 101 and components of the system 101, in accordance with the embodiment of the present disclosure.

FIG. 3 illustrates a method 300 for dynamically controlling pricing information associated with one or more products of a self-service terminal, in accordance with an embodiment of the present subject matter.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that, the singular forms “a,” “an,” and “the” include plural references unless the context clearly dictates otherwise. Although any methods similar or equivalent to those described herein can be used in the practice or testing of embodiments of the present disclosure, the exemplary methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

Though the below description, in conjunction with the drawings, has been described considering the self-service terminal as a vending device, however, the present disclosure is not necessarily limited to the vending device as described below and the self-service terminal herein may include any unmanned device that may be used for self-service.

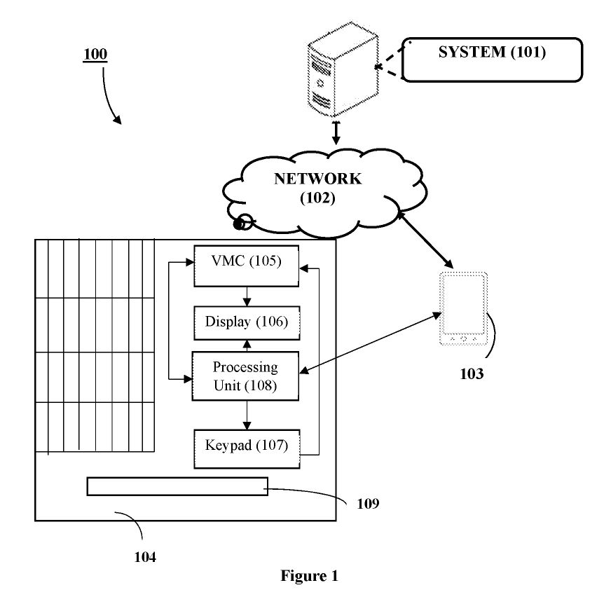

Referring to FIG. 1, a network implementation 100 of a system 101 for dynamically controlling pricing information associated with one or more products of a self-service terminal is illustrated, in accordance with an embodiment of the present subject matter. As shown in FIG. 1, a vending device 104 may be provided further comprising a vending machine controller (also to be referred as VMC hereinafter) 105, a display 106, a keypad 107 and a processing unit 108. In one embodiment, the processing unit 108 may comprise one or more UART ports (Not shown in the FIG. 1). In one embodiment, the processing unit 108 may be electronically coupled with the VMC 105. The processing unit 108 may be communicatively coupled with a user device 103. In one embodiment, the processing unit 108 may communicate with the user device 103 through a short range wireless communication protocol selected from a group comprising, but not limited to, Bluetooth communication protocol, Near Field Communication (NFC), Radio Frequency (RF) protocol, an infra-red (IR) protocol, and the like. In another embodiment, the processing unit 108 may communicate with the user device 103 through a router (not shown) present within the vending device 104. Further, the user device 103 may be communicatively coupled with the system 101.

In one embodiment, the vending device 104 may comprise plurality of products arranged in the rows of the storage area. In one exemplary embodiment, each row may comprise plurality of columns wherein each column may comprise plurality of products.

Although the present subject matter is explained considering that the system 101 is implemented as on a server, it may be understood that the system 101 may also be implemented in a variety of computing systems, such as a laptop computer, a desktop computer, a notebook, a workstation, a mainframe computer, a server, a network server, and the like. It will be understood that the system 101 may be accessed by multiple users through one or more user devices 103-1, 103-2 . . . 103-N, collectively referred to as user 103 hereinafter, or applications residing on the user devices 103. Examples of the user devices 103 may include, but are not limited to, a portable computer, a personal digital assistant, a handheld device, and a workstation. The user devices 103 are communicatively coupled to the system 101 through a network 102.

In one implementation, the network 102 may be a wireless network, a wired network or a combination thereof. The network 102 can be accessed by the user device 104 using wired or wireless network connectivity means including updated communications technology. The network 102 can be implemented as one of the different types of networks, such as intranet, local area network (LAN), wide area network (WAN), the internet, and the like. The network 102 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 102 may include a variety of network devices, including routers, bridges, servers, computing devices, storage devices, and the like.

In one embodiment, the system 101 may be configured to enable the operator to scan, via the user device 103, QR code displayed on the vending device 104. In one embodiment, the QR code comprises details of the vending device 104 in order to perform verification of the identified vending device 104. In one embodiment, the system 101 implemented on the operator device 103 may enable the operator to communicate with the vending device 104. In one embodiment, the operator device 103 may display products available in the vending device 104.

In one embodiment, the system 101 may be configured to display a planogram on the operator device 103. In one embodiment, the planogram comprises matrix of rows and columns accommodating a plurality of products associated with self-service terminal. In one embodiment, intersection of a row and a column indicates a cell or a compartment. In one embodiment, the cell or the compartment may accommodate a product of the plurality of products.

The system 101 may be configured to enable an operator to dynamically set a price associated with an individual product within an individual cell of the matrix. In one embodiment, the operator may set the price of the one or more products through operator device. In one embodiment, the price set for the said individual product may either same or different from one or more products within a same row or a same column, corresponding to said individual product, in the matrix. In one exemplary embodiment, the operator device 103 may set the value of the product of the vending device based upon a voice command received from the operator. The vending device may also provide an audio assistance to the operator at the time of setting the price of plurality of product. In some embodiments, the user device and the vending device may enable the operator to interact with either of the user device or the vending device through tactile inputs. In some embodiments, the user device and vending device may be configured to interact with the user through gesture control mechanism.

In one embodiment, the processing unit 108 of the vending device 104 may receive updated price of the plurality of products from the operator device 103. In one embodiment, the processing unit 108 may communicate with the user device 103 through a short range wireless communication protocol. In one embodiment, the processing unit 108 may be configured to update the price of the plurality of products stored in the VMC 105 for both cash or cashless transactions. In one embodiment, the processing unit 108 may be configured to update the price of the plurality of products stored in the VMC 105 through the MDB protocol. In one embodiment, the VMC 105 is configured to display updated price on the display 106 of the vending device 104.

In one embodiment, the system 101 may be configured to update the price of the plurality of products stored in the inventory. In one embodiment, the system 101 may display the list of products with updated price on the user device 103. The system 101 may enable user device 103 to select the one or more product. In one embodiment, the system 101 may enable user to customize the product based on the requirement.

In one embodiment, the system 101 may be configured to generate a unique code based upon electronic transaction corresponding to each product selected by the one or more user devices. In one embodiment, the unique code is indicative of validity of the electronic transaction in accordance with the price set for each product selected by the one or more user devices. Further, the system 101 may be configured to transmit the unique code to a processing unit 108 within the self-service terminal. In one embodiment, the processing unit is capable of decoding vending information residing in the unique code and thereby triggering a controller of the self-service terminal to initiate dispensing of the one or more products from the self-service terminal.

In one embodiment, the system 101 may configured to analyse the dispense history of the one or more products through the self-service terminal to obtain updated inventory information. In one embodiment, the updated inventory information may be used generate an updated planogram. Further, system 101 may enable the operator to reset the price associated to the one or more products based upon the updated inventory information. In one embodiment, the operator may reset the price associated with the one or more products using the operator device 103.

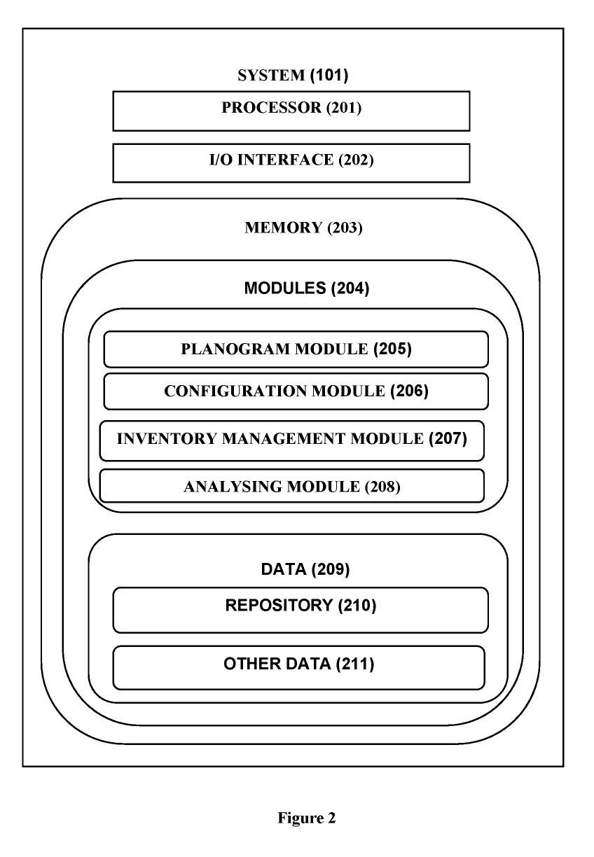

Now referring to FIG. 2, components of the system 101 are illustrated in accordance with an embodiment of the present subject matter. The system 101 may comprise at least one processor 201, an input/output (I/O) interface 202, a memory 203, modules 204 and data 209. In one embodiment, the at least one processor 201 is configured to fetch and execute computer-readable instructions stored in the memory 203.

In one embodiment, the I/O interface 202 may include a variety of software and hardware interfaces, for example, a web interface, a graphical user interface, and the like. The I/O interface 202 may allow the system 101 to interact with the operator devices 103. Further, the I/O interface 202 may enable the operator device 103 to communicate with other computing devices, such as web servers and external data servers (not shown). The I/O interface 202 can facilitate multiple communications within a wide variety of networks and protocol types, including wired networks, for example, LAN, cable, etc., and wireless networks, such as WLAN, cellular, or satellite. The I/O interface 202 may include one or more ports for connecting to another server.

In an implementation, the memory 203 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and memory cards. The memory 203 may include modules 204 and data 208.

The modules include routines, programs, objects, components, data structures, etc., which perform particular tasks, functions or implement particular abstract data types. In one implementation, the modules may include a planogram module 205, a configuration module 206, an inventory management module 207, analysing module 208 other modules (not shown in figure). The other modules may include programs or coded instructions that supplement applications and functions of the user device.

In one embodiment, the data 209 may comprise repository 210 and other data 211. In one exemplary embodiment, the repository 209 may be configured to store data processed, received, and generated by one or more of the modules 204. In one exemplary embodiment, the repository 210 may store database of the vending devices, list of one or more products available in vending devices, price associated with one or more products. The other data 211 may include data generated as a result of the execution of one or more modules.

In one implementation, an operator may use the user device 103 to register with the system 101 via I/O interface 202. The operator may use an application installed on the user device 103 in order to register with the system 101.

In one embodiment, the planogram module 205 may be configured to display the planogram on the operator device 103. In one embodiment, the planogram may comprise matrix of rows and columns accommodating a plurality of products associated with self-service terminal. In one embodiment, intersection of a row and a column indicates a cell or a compartment. In one embodiment, the cell or the compartment may accommodate a product of the plurality of products. In one embodiment, each cell or each compartment of the row may comprise same or different product than the other. In one exemplary embodiment, diet coke, water bottle, apple juice etc. are placed in plurality of columns of the same row with different price. In another exemplary embodiment, the row comprises same product in plurality of columns such as diet coke but price associated with diet coke of each column may be different based on the offers, nutritional values etc.

In one embodiment, the configuration module 206 may enable the operator to dynamically set a price associated with an individual product within an individual cell of the matrix through the operator device 103. In one embodiment, the operator device 103 may be within predefined range of the location of self-service terminal. In another embodiment, the configuration module 206 may enable the operator to dynamically set a price associated with an individual product within an individual cell of the matrix through the input/output interface of the system 101 implemented on the remote server. In one embodiment, the price set for the said individual product is either same or different from one or more products within a same row or a same column, corresponding to said individual product, in the matrix. In one exemplary embodiment, the operator may set the price of the product based on real time or frequently updated feed received from the product supplier. In one exemplary embodiment, the operator may set discounted price for limited coke bottles in the one column of the plurality of columns.

In one embodiment, the analysing module 208 may be configured to analyse the dispense history of the one or more products associated with the self-service terminal. The dispense history of the one or more products may be analysed in order to update the inventory information. In one embodiment, the analysing module 207 may provide product recommendations to the operator based on the analysis of the prior dispensed products. Based on the analysis, the system 101 may enable operator to reset the price associated to the one or more products. In one embodiment, the analysis module 207 may suggest prices of the one or more products based on the analysis of the various parameters such as demand and/or supply of the one or more products, shelf life of the one or more products, consumption pattern of the one or more products, consumer behaviour pattern associated with purchasing of the one or more products, inventory information of the self-service terminal, and the location of the self-service terminal. In one embodiment, the analysing module 207 may identify the demand and/supply of the one or more products by analysing historical sales data. Further, the analysing module 207 may calculate the price of the one or more products based on the demand at a specific time interval of a day/time and the stock of the one or more products available in the self-service terminal. In one embodiment, the analysing module 207 may calculate a discount value for the one or more products having low demand. Further, the analysing module 207 may analyse a shelf life of the one or more products stored in the self-service terminal. In one embodiment, the analysing module 207 may calculate discount value for the one or more products having less shelf life. In one embodiment, the analysing module 207 may calculate price of the one or more products based on the geographical location of the vending device. In one embodiment, the analysing module 207 may calculate price of the one or more products based on the inventory information of the self-service terminal.

In one embodiment, the inventory management module 207 may be configured to update the list of available products in the vending device based on the analysis performed by the analysing module 208. In one embodiment, the planogram module 205 may be configured to generate the updated planogram based on the updated inventory information.

In one embodiment, the operator device 103 or the user device 103 may transmit updated price of the plurality of products to the processing unit 108 using the wireless communication protocol selected from a group comprising, but not limited to, Bluetooth communication protocol, Near Field Communication (NFC), Radio Frequency (RF) protocol, an infra-red (IR) protocol, and the like. The processing unit 108 may be configured to update the price of the plurality of products stored in the VMC 105 through the MDB protocol. In one embodiment, the VMC 105 may display the updated list of products and associated price on the vending device 104.

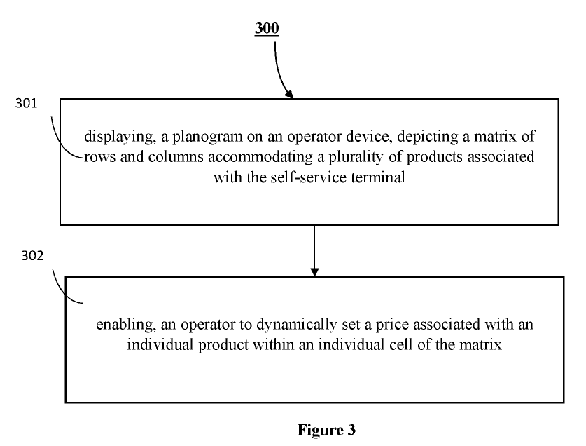

Now referring to FIG. 3, a method for dynamically controlling pricing information associated with one or more products of a self-service terminal, in accordance with an embodiment of the present subject matter is illustrated.

As shown, at step 301, the system 101 may be configured to display a planogram on the operator device 103. In one embodiment, the planogram comprises matrix of rows and columns accommodating a plurality of products associated with self-service terminal. In one embodiment, intersection of a row and a column indicates a cell or a compartment. In one embodiment, the cell or the compartment may accommodate a product of the plurality of products.

At shown 302, the system 101 may be configured to enable an operator to dynamically set a price associated with an individual product within an individual cell of the matrix. In one embodiment, the operator may set the price of the one or more products through operator device. In one embodiment, the price set for the said individual product may either same or different from one or more products within a same row or a same column, corresponding to said individual product, in the matrix.

Although implementations for method and system for dynamically controlling the pricing information of the self-service terminal have been described in language specific to structural features and/or methods, it is to be understood that the appended claims are not necessarily limited to the specific features or methods described. Rather, the specific features and methods are disclosed as examples of implementations for dynamically controlling the pricing information of the self-service terminal.

What is claimed is:

1. A system for dynamically controlling pricing information associated with one or more products of a self-service terminal, the system comprising:
one or more processors;
a memory coupled to the one or more processors, wherein the memory stores programmed instructions to be executed by the one or more processors, the programmed instructions comprising instructions for
displaying, on an operator device, a planogram depicting a matrix of rows and columns accommodating a plurality of products associated with the self-service terminal, wherein an intersection of a row and a column indicates a cell accommodating a product of the plurality of products; and
enabling, via operator device or a remote server, an operator to dynamically set a price associated with an individual product within an individual cell of the matrix, wherein the price set for the said individual product is either same or different from one or more products within a same row or a same column, corresponding to said individual product, in the matrix.

2. The system of claim 1 further comprising a repository for storing the price set for each of the plurality of products.

3. The system of claim 2, wherein the programmed instructions further comprises instructions for displaying, on one or more consumer devices, a list of products along with price set for each product in the list of products for enabling one or more consumers to select at least one product.

4. The system of claim 1, wherein the programmed instructions further comprises instructions for analyzing the dispense history of the one or more products through the self-service terminal to obtain updated inventory information and thereby generate an updated planogram thereof.

5. The system of claim 1, wherein the programmed instructions further comprises instructions for analysing demand of the one or more products, supply of the one or more products, shelf life of the one or more products, consumption pattern associated with the one or more products, consumer behaviour pattern, inventory information of the self-service terminal, and the location of the self-service terminal in order to calculate and suggest price of each product to the operator.

6. The system of claim 4, wherein the programmed instructions further comprises instructions for enabling the operator, via the operator device, to reset the price associated to the one or more products based upon the updated inventory information.

7. A method for dynamically controlling pricing information associated with one or more products of a self-service terminal, the method comprising:
displaying, via one or more processor, a planogram on an operator device, depicting a matrix of rows and columns accommodating a plurality of products associated with the self-service terminal, wherein an intersection of a row and a column indicates a cell accommodating a product of the plurality of products; and
enabling, via one or more processor, an operator to dynamically set a price associated with an individual product within an individual cell of the matrix using the operator device or remote server, wherein the price set for the said individual product is either same or different from one or more products within a same row or a same column, corresponding to said individual product, in the matrix.

8. The method of claim 7, further comprising displaying on one or more consumer devices, a list of products along with price set for each product in the list of products for enabling one or more consumers to select at least one product.

9. The method of claim 7, further comprising analysing the dispense history of the one or more products through the self-service terminal to obtain updated inventory information and thereby generate an updated planogram thereof.

10. The method of claim 7, further comprising enabling the operator to reset the price associated to the one or more products based upon the updated inventory information.

11. The method of claim 7, further comprising analysing demand of the one or more products, supply of the one or more products, shelf life of the one or more products, consumption pattern associated with the one or more products, consumer behaviour pattern, inventory information of the self-service terminal, and the location of the self-service terminal in order to calculate and suggest price of each product to the operator.

12. A non-transitory computer readable medium storing program for dynamically controlling pricing information associated with one or more products of a self-service terminal, the program comprising programmed instructions, the programmed instructions comprising instructions for:
displaying, on an operator device, a planogram depicting a matrix of rows and columns accommodating a plurality of products associated with the self-service terminal, wherein an intersection of a row and a column indicates a cell accommodating a product of the plurality of products; and
enabling, via operator device or a remote server, an operator to dynamically set a price associated with an individual product within an individual cell of the matrix, wherein the price set for the said individual product is either same or different from one or more products within a same row or a same column, corresponding to said individual product, in the matrix.
